(19) United States
(12) Patent Application Publication
(10) Pub. No.: US 2026/0290010 A1
(43) Pub. Date: Sep. 24, 2026

(54) IMAGE ANALYSIS APPARATUS, IMAGE ANALYSIS METHOD, AND NON-TRANSITORY COMPUTER-READABLE MEDIUM

(71) Applicant: NEC Aerospace Systems, Ltd., Tokyo (JP)

(72) Inventors: Daisuke SUGIDOMARI, Tokyo (JP); Hiroshi OUCHI, Tokyo (JP)

(73) Assignee: NEC Aerospace Systems, Ltd., Tokyo (JP)

(21) Appl. No.: 19/474,381

(22) PCT Filed: Apr. 30, 2024
(86) PCT No.: PCT/JP2024/016649

§ 371 Date: Oct. 10, 2025

(30) Foreign Application Priority Data
May 1, 2023 (JP) 2023-075670

(51) Int. Cl. G06V 20/30; G06V 10/94; G06V 40/10

(52) U.S. Cl. CPC G06V 20/30; G06V 10/945; G06V 40/10

(57) ABSTRACT

This image analysis device comprises an attribute information acquisition unit, a designation input reception unit, a related person identification unit, and a display output unit. The attribute information acquisition unit processes a plurality of images, thereby acquiring, for each individual person appearing in each image, attribute information indicating the attribute of the person. The designation input reception unit receives a person designation input indicating a designated person. The related person identification unit identifies a related person, who is a person related to the designated person, by using the attribute information acquired for each individual person. The display output unit outputs a screen image including person relationship information indicating the relationship between the designated person and the related person, and organization information relating to an organization to which each of the designated person and the related person belong.

### DESCRIPTION

### Technical Field

The present invention relates to an image analysis device, an image analysis method, and a recording medium.

### Background Art

Techniques for identifying a specific person by analyzing an image are utilized in various scenes.

An example of a technique for identifying a specific person by analyzing an image is disclosed in PTL 1 below. PTL 1 discloses a technique for identifying a specific person and a potential colleague of the person based on an input video. For example, PTL 1 discloses a method for determining a potential colleague for a specific person based on the number of times the specific person and other persons appear simultaneously.

### CITATION LIST

### Patent Literature

PTL 1: JP 2023-018113 A

### SUMMARY OF INVENTION

### Technical Problem

In a case where a specific person and a person related to the person are identified from a certain video, there is a need to grasp a relationship between the persons. In the technique of Cited Document 1, this relationship is not determined.

In view of the above-described problems, one object of the present invention is to provide an image analysis device, an image analysis method, and a program (recording medium in which the program is recorded) for easily grasping a relationship between a specific person and a person related to the person identified from a video.

### Solution to Problem

An image analysis device according to the present disclosure includes
an attribute information acquisition means for acquiring attribute information indicating an attribute of a person for each individual person photographed in each image by processing a plurality of images,
a designation input accepting means for accepting a person designation input indicating a designated person,
a related person identification means for identifying a related person who is a person related to the designated person by using the attribute information acquired for each individual person, and
a display output means for outputting a screen including person relationship information indicating a relationship between the designated person and the related person and organization information regarding an organization to which each of the designated person and the related person belongs.

An image analysis method according to the present disclosure includes
at least one computer
acquiring attribute information indicating an attribute of a person for each individual person photographed in each image by processing a plurality of images,
accepting a person designation input indicating a designated person,
identifying a related person who is a person related to the designated person by using the attribute information acquired for each individual person, and
outputting a screen including person relationship information indicating a relationship between the designated person and the related person and organization information regarding an organization to which each of the designated person and the related person belongs.

A recording medium according to the present disclosure records
a program to be executed by at least one computer to cause the computer to execute operations including
acquiring attribute information indicating an attribute of a person for each individual person photographed in each image by processing a plurality of images,
accepting a person designation input indicating a designated person,
identifying a related person who is a person related to the designated person by using the attribute information acquired for each individual person, and
outputting a screen including person relationship information indicating a relationship between the designated person and the related person and organization information regarding an organization to which each of the designated person and the related person belongs.

### Advantageous Effects of Invention

According to one aspect of the present invention, for example, a person who performs a confirmation work of a video can easily grasp a relationship among a plurality of persons identified from a video.

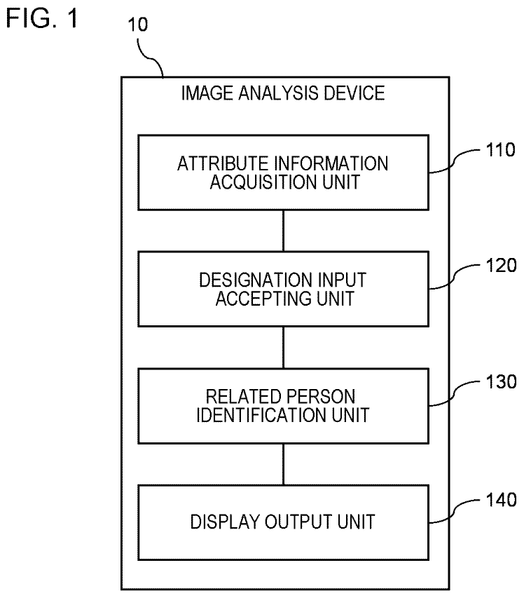

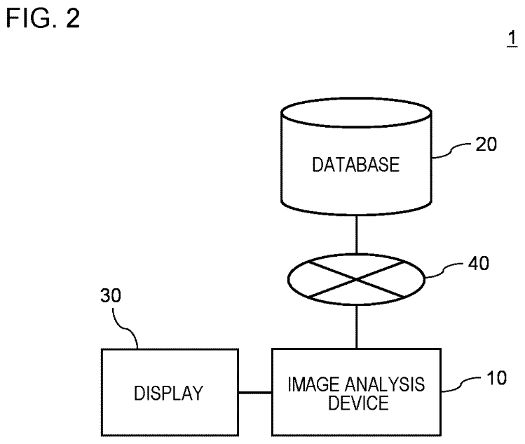

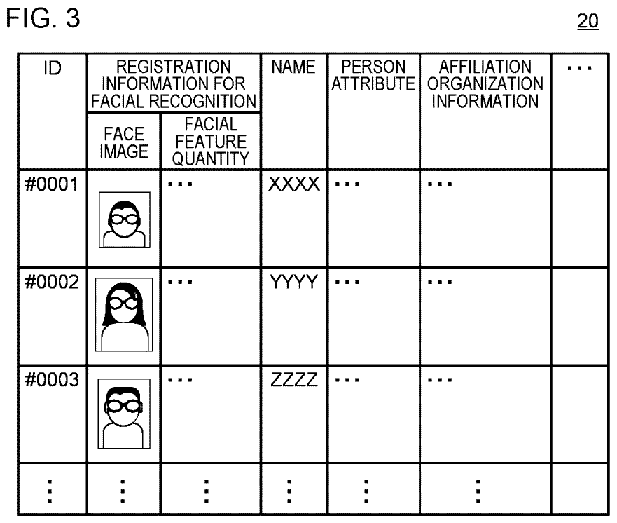

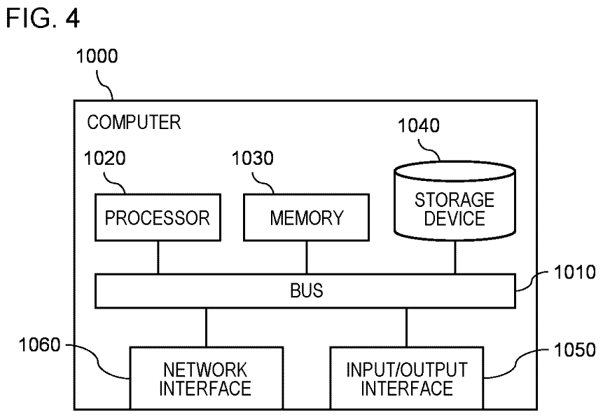

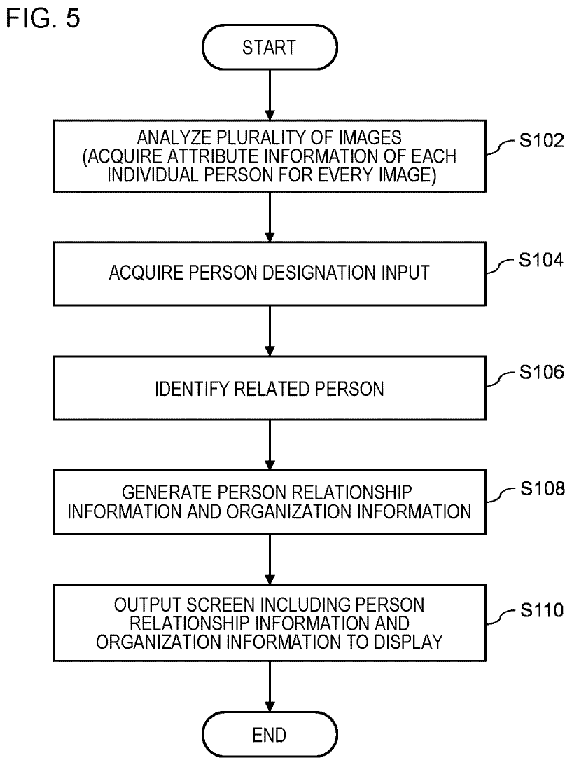

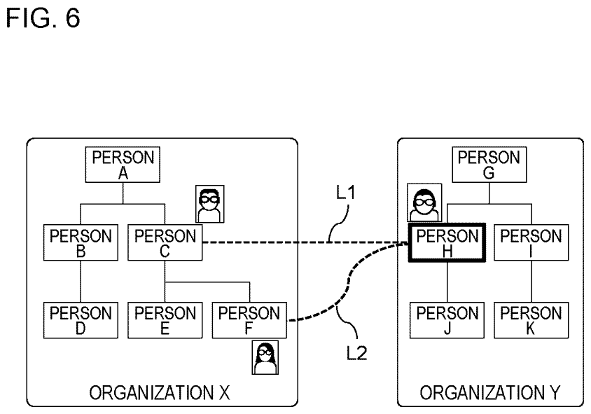

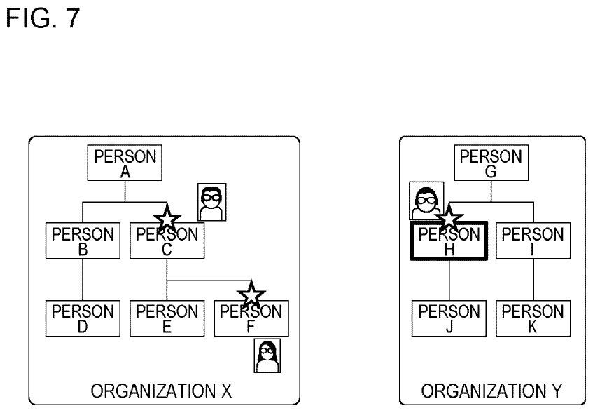

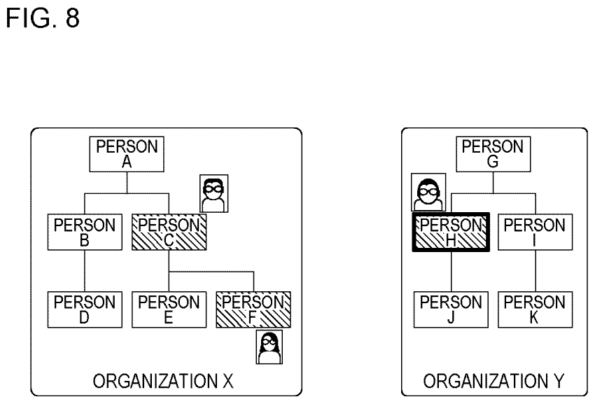

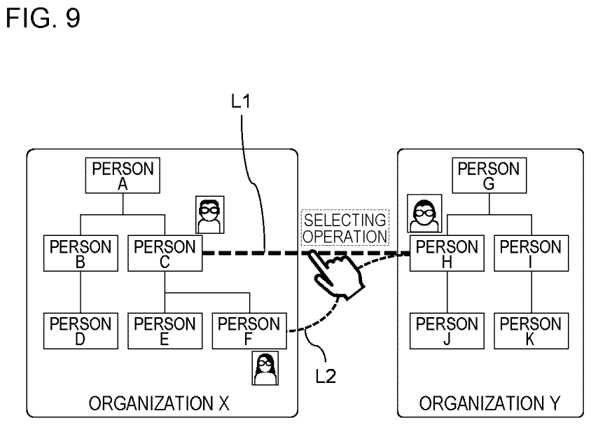

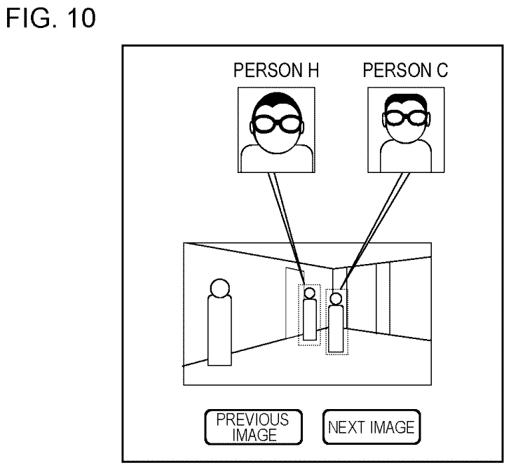

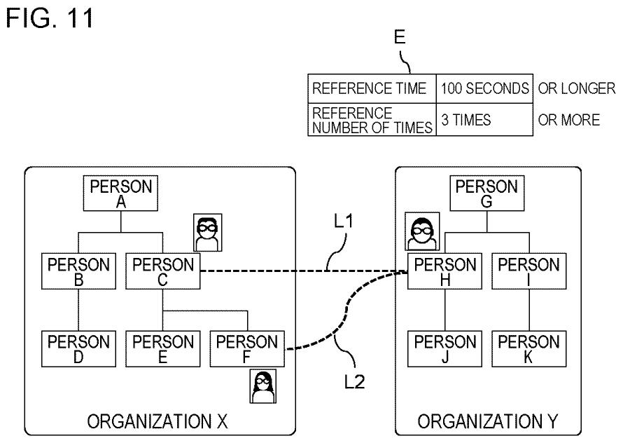

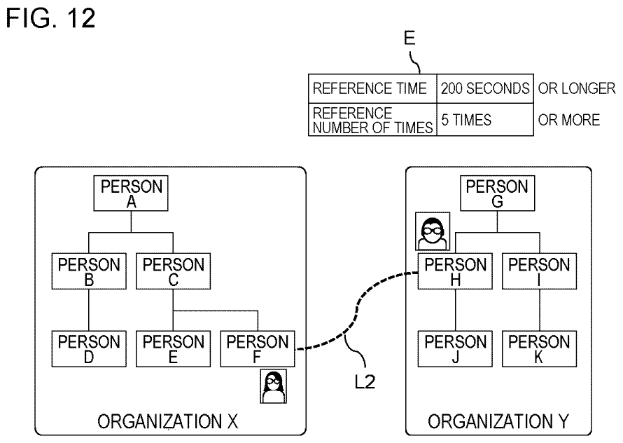

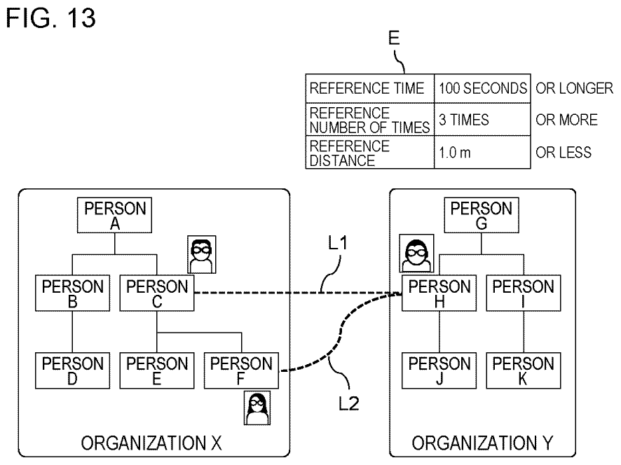

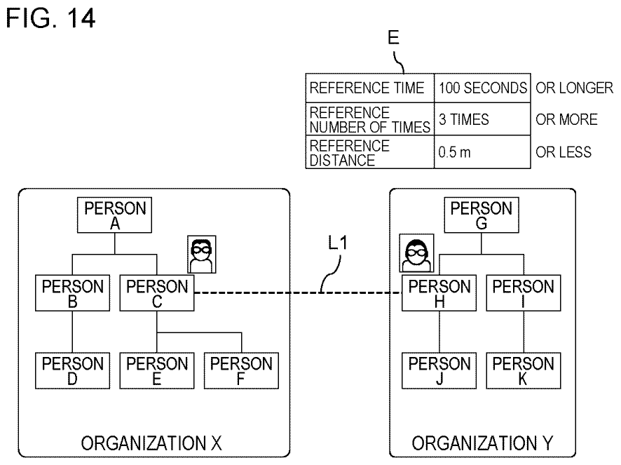

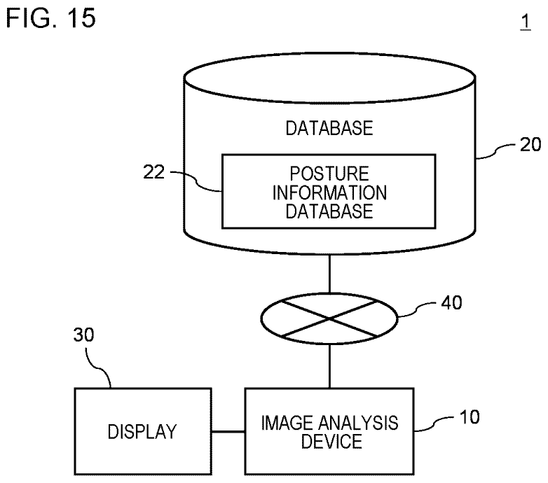

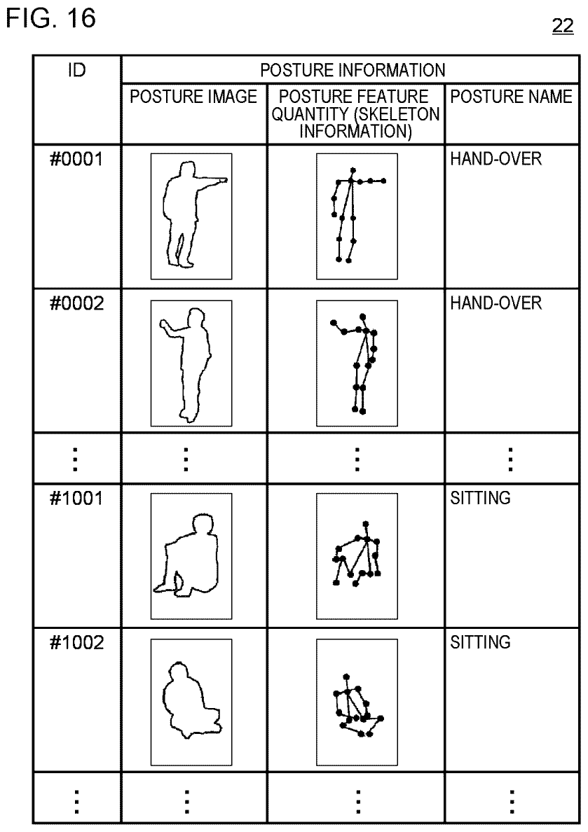

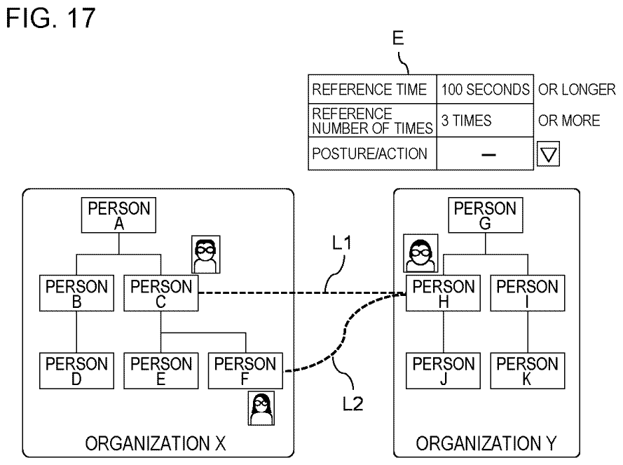

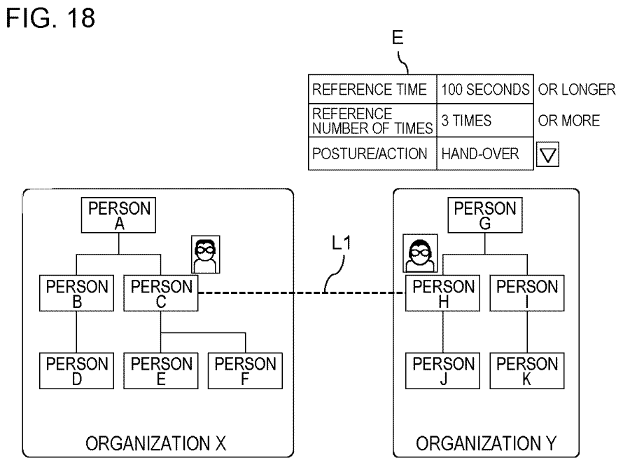

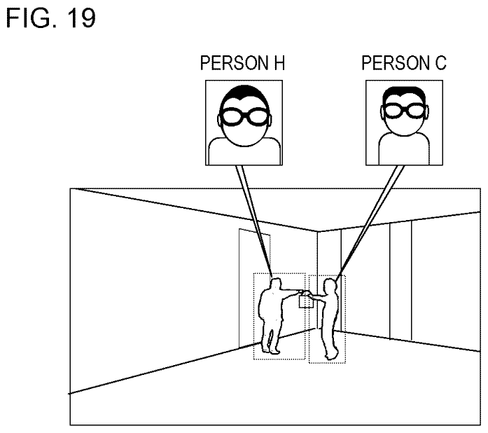

### BRIEF DESCRIPTION OF DRAWINGS

[FIG. 1] It is a diagram illustrating an outline of an image analysis device according to a first example embodiment.

[FIG. 2] It is a diagram illustrating a system configuration of an image analysis system configured to include the image analysis device.

[FIG. 3] It is a diagram illustrating an example of information stored in a database.

[FIG. 4] It is a diagram illustrating a hardware configuration of a computer that achieves the image analysis device.

[FIG. 5] It is a flowchart illustrating processing executed by an image analysis device according to a second example embodiment.

[FIG. 6] It is a diagram illustrating an example of a screen output by a display output unit.

[FIG. 7] It is a diagram illustrating another example of a screen output by the display output unit.

[FIG. 8] It is a diagram illustrating another example of a screen output by the display output unit.

[FIG. 9] It is a diagram for explaining an operation of an image analysis device (display output unit) according to a first modified example of a second example embodiment.

[FIG. 10] It is a diagram for explaining an operation of an image analysis device (display output unit) according to the first modified example of the second example embodiment.

[FIG. 11] It is a diagram for explaining the operation of an image analysis device (the related person identification unit and the display output unit) according to a second modified example of the second example embodiment.

[FIG. 12] It is a diagram illustrating a screen updated according to an input for changing a reference.

[FIG. 13] It is a diagram for explaining the operation of an image analysis device (the related person identification unit and the display output unit) according to a third modified example of the second example embodiment.

[FIG. 14] It is a diagram illustrating a screen updated according to an input for changing a reference.

[FIG. 15] It is a diagram illustrating a system configuration of an image analysis system 1 according to a third example embodiment.

[FIG. 16] It is a diagram illustrating an example of information stored in a posture information database.

[FIG. 17] It is a diagram for explaining the operation of the image analysis device (the related person identification unit and the display output unit) according to the third example embodiment.

[FIG. 18] It is a diagram for explaining the operation of the image analysis device (the related person identification unit and the display output unit) according to the third example embodiment.

[FIG. 19] It is a diagram for explaining the operation of the image analysis device (the related person identification unit and the display output unit) according to the third example embodiment.

### EXAMPLE EMBODIMENT

Hereinafter, example embodiments of the present invention will be described with reference to the drawings. In all the drawings, the same components are denoted by the same reference numerals, and the description thereof will be omitted as appropriate. Unless otherwise described, in each block diagram, each block represents not a configuration of a hardware unit but a configuration of a functional unit. In a case where elements such as blocks in the figure are linked by arrows, the directions of the arrows are merely intended to facilitate understanding of the flow of information. In this case, the direction of the arrow does not limit the direction of communication (one-way communication/two-way communication) unless otherwise specified.

In the following description, “acquisition” includes at least one of a host device going to obtain data or information stored in another device or a storage medium (active acquisition) and inputting data or information output from another device to the host device (passive acquisition). Examples of the active acquisition include requesting or inquiring another device and receiving a reply thereto, and accessing and reading another device or a storage medium. Examples of passive acquisition include reception of information to be distributed (alternatively, transmission, push notification, and the like). Further, “acquisition” may be selecting and acquiring from among received data or information or selecting and receiving distributed data or information.

### First Example Embodiment

FIG. 1 is a diagram illustrating an outline of an image analysis device 10 according to a first example embodiment. The image analysis device 10 illustrated in this drawing includes an attribute information acquisition unit 110, a designation input accepting unit 120, a related person identification unit 130, and a display output unit 140.

The attribute information acquisition unit 110 processes a plurality of input images. The attribute information acquisition unit 110 acquires, for each individual person photographed in each image, attribute information indicating an attribute of the person based on a processing result of each image. The designation input accepting unit 120 accepts a person designation input indicating a certain person. In the following description, a person indicated by the person designation input is also referred to as a “designated person”. The related person identification unit 130 identifies a person related to the designated person by using the attribute information acquired for each individual person. In the following description, a person related to the designated person is also referred to as a “related person”. The display output unit 140 outputs a screen including the person relationship information and the organization information to an output device such as a display. Here, the “person relationship information” is information indicating the relationship between the designated person and the related person. Furthermore, the “organization information” is information on an organization to which each of the designated person and the related person belongs. Specific examples of the person relationship information and the organization information will be described later.

According to the present example embodiment, the attribute information of each individual person is acquired for every image by processing each of a plurality of images. Then, in a case where a certain person is identified as the designated person, a person related to the designated person is identified based on the attribute information acquired for every image. Then, a screen including the person relationship information indicating the relationship between the designated person and the specific person and the organization information regarding the organization to which each person belongs is output. That is, an image analysis device and an image analysis method for enabling a relationship between a specific person and a person related to the person to be easily grasped are provided. Furthermore, as can be seen from the description of a second example embodiment to be described later, a program for implementing the function of the image analysis device 10, which is a means for solving the above problem, on at least one computer, and a non-transitory computer readable recording medium storing the

Hereinafter, in another example embodiment, a detailed example of the image analysis device 10 will be described.

### Second Example Embodiment

FIG. 2 is a diagram illustrating a system configuration of the image analysis system 1 including the image analysis device 10. The image analysis system 1 illustrated in FIG. 2 includes an image analysis device 10, a database 20, and a display 30. The image analysis device 10 and the database 20 are connected via a network 40. In addition, the display 30 is connected as a display for the image analysis device 10 via an input interface (not illustrated) of the image analysis device 10. The configuration of the image analysis system 1 is not limited to the example illustrated in the drawing. For example, the database 20 may be constructed in a storage area inside the image analysis device 10. Furthermore, for example, the display 30 may be a display of a computer (not illustrated) connected to the image analysis device 10 via the network 40.

As illustrated in FIG. 3, the database 20 stores various types of information regarding various persons. FIG. 3 is a diagram illustrating an example of information stored in the database 20. In the example of FIG. 3, the database 20 stores registration information for facial recognition, a name of a person, a person attribute, and affiliation organization information. Here, the registration information for facial recognition includes at least one of a face image and a feature quantity that can be extracted based on the face image. In addition, the person attribute includes an arbitrary attribute that is an attribute other than the facial feature and can be used to identify at least one person from the image. For example, the person attribute includes information regarding physical characteristics (combinations of various features such as skeletal shape, height, body size, hair color, and skin color) of the person. The person attribute may further include other attributes such as age and gender in addition to these arbitrary attributes. In addition, the affiliation organization information includes information for identifying an organization to which the target person belongs, information indicating a position and a hierarchy in the organization, and the like. Furthermore, the affiliation organization information may further include information indicating a system (structure) of the relevant organization.

The information illustrated in FIG. 3 is, for example, accumulated as follows. First, the image analysis device 10 or a management terminal (not illustrated) accepts, as an input, a face image of a target person, information regarding an attribute of the person, and information regarding an affiliation organization. Then, the image analysis device 10 or a management terminal (not illustrated) collects information accepted as an input and generates one record. Then, the image analysis device 10 or the management terminal (not illustrated) stores the generated record in the database 20. In this manner, the information as illustrated in FIG. 3 is accumulated in the database 20.

The image analysis device 10 includes at least the attribute information acquisition unit 110, the designation input accepting unit 120, the related person identification unit 130, and the display output unit 140 described in the first example embodiment.

FIG. 4 is a diagram illustrating a hardware configuration of a computer 1000 that achieves the image analysis device 10.

The computer 1000 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, a method of connecting the processor 1020 and the like to each other is not limited to the bus connection.

The processor 1020 is a Central Processing Unit (CPU), a Graphics Processing Unit (GPU), or the like.

The memory 1030 is a main storage device implemented by a Random Access Memory (RAM) or the like.

The storage device 1040 is an auxiliary storage device implemented by a Hard Disk Drive (HDD), a Solid State Drive (SSD), a memory card, a Read Only Memory (ROM), or the like. The storage device 1040 stores at least a program module that achieves the function (attribute information acquisition unit 110, designation input accepting unit 120, related person identification unit 130, and display output unit 140) of the image analysis system 1 described above. In addition, the storage device 1040 may serve as the database 20.

The processor 1020 achieves a function related to the program module by developing the program module read from the storage device 1040 into the memory 1030 and executing the program module. For example, the processor 1020 achieves the function of the attribute information acquisition unit 110 described in the present disclosure by reading a program module related to the attribute information acquisition unit 110 into the memory 1030 and executing the program module. Similarly, the processor 1020 achieves the function of the designation input accepting unit 120 described in the present disclosure by reading a program module related to the designation input accepting unit 120 into the memory 1030 and executing the program module. Similarly, the processor 1020 achieves the function of the related person identification unit 130 described in the present disclosure by reading a program module related to the related person identification unit 130 into the memory 1030 and executing the program module. Similarly, the processor 1020 achieves the function of the display output unit 140 described in the present disclosure by reading the program module related to the display output unit 140 into the memory 1030 and executing the program module. The operation of the processor 1020 is common to the example embodiments included in the present disclosure.

The program modules described above may be recorded in a recording medium other than the storage device 1040. The recording medium for recording the program module includes any medium that can be used by the non-transitory tangible computer 1000. A program code readable by the computer 1000 (processor 1020) may be embedded in the recording medium for recording the program modules.

The input/output interface 1050 is an interface for connecting the computer 1000 (image analysis device 10) and various types of input/output devices. For example, an output device such as the display 30 is connected to the computer 1000 (image analysis device 10) via the input/output interface 1050.

The network interface 1060 is an interface for connecting the computer 1000 (image analysis device 10) to a network. The network includes, for example, a Local Area Network (LAN), a Wide Area Network (WAN), and the like. The network interface 1060 connects the computer 1000
(image analysis device 10) to various types of networks by wireless or wired connection. The computer 1000 (image analysis device 10) can communicate with, for example, the database 20 via the network interface 1060.

Furthermore, the computer 1000 (image analysis device 10) can be connected to various types of devices (not illustrated) via the input/output interface 1050 or the network interface 1060. The “various types of devices” mentioned here are not particularly limited, but are, for example, input devices such as an operation button, a keyboard, a touch panel, and a mouse, and output devices such as a speaker, a microphone, and a printer.

FIG. 5 is a flowchart illustrating processing executed by the image analysis device 10 according to the second example embodiment.

First, the attribute information acquisition unit 110 acquires a plurality of images (e.g., moving image data etc.) to be processed, and analyzes each image (step S102). The attribute information acquisition unit 110 acquires the attribute information of each individual person for every image as a result of the analysis processing of each image.

As an example, the attribute information acquisition unit 110 acquires a face image of each individual person or a facial feature quantity based on the face image, a whole-body image of each individual person or skeleton information based on the whole-body image, and the like as attribute information of each individual person. In this case, the attribute information acquisition unit 110 first identifies an image region (hereinafter also referred to as a “person region”) corresponding to each of persons photographed in a plurality of images to be processed. The attribute information acquisition unit 110 generates skeleton information of each person from the person region identified for each person. The attribute information acquisition unit 110 can generate the skeleton information from the person region by using a known image processing algorithm (e.g., an image processing algorithm for identifying a joint part or the like of a person from an image of the person). Furthermore, the attribute information acquisition unit 110 can further extract a region of a face portion (hereinafter also referred to as a “face region”) from the person region. The attribute information acquisition unit 110 can extract the face region of each individual person by using a known face recognition algorithm. In this case, the attribute information acquisition unit 110 may generate the facial feature quantity information from the face region of each individual person. Then, the attribute information acquisition unit 110 acquires information (face region, facial feature information, skeleton information, etc.) obtained for each individual person as attribute information of each individual person. The attribute information of each individual person acquired by the attribute information acquisition unit 110 is collated with information regarding each person in the database 20. As a result of the collation, each individual person photographed in each image is identified. The identification result of each individual person is stored in a storage area of the image analysis device 10 such as, for example, the memory 1030 or the storage device 1040.

The image analysis device 10 may further have a function of generating a list of persons identified based on the identification result of each individual person and outputting the list to the display 30. Furthermore, the image analysis device 10 may further have a function of performing processing of giving information (e.g., a rectangular frame) indicating the region of each individual person to each image and outputting a screen including the processed image to the display 30.

Next, the designation input accepting unit 120 acquires a person designation input (step S104). For example, the designation input accepting unit 120 accepts an input operation of information for identifying the designated person via an input device connected to the input/output interface 1050. The input operation includes, for example, an operation of selecting a designated person from the person list displayed on the display 30, an operation of selecting a region corresponding to the designated person in the image displayed on the display 30, and the like. In addition, the designation input accepting unit 120 may accept another image (query image) regarding the designated person as an input.

Next, the related person identification unit 130 identifies a related person with respect to the designated person indicated by the person designation input (step S106). In the processing of step S102, the related person identification unit 130 identifies a related person with respect to the designated person by using the attribute information of each individual person acquired from each image.

For example, the related person identification unit 130 can identify a related person as follows. First, the related person identification unit 130 calculates at least one of the time of being with the designated person and the number of times appearing with the designated person based on the attribute information of each individual person acquired from each image. For example, assume that, as a result of the attribute information acquisition unit 110 processing moving image data (a plurality of images) photographed at 30 fps, the attribute information of the first person corresponding to the designated person and the attribute information of the second person different from the designated person are simultaneously acquired in three sections in the moving image. Furthermore, assume that the three sections are a first section (300 frames), a second section (900 frames), and a third section (600 frames). In this case, the related person identification unit 130 can calculate the time during which the first person and the second person are together by adding the times corresponding to each section. That is, the related person identification unit 130 can calculate the time during which the first person (designated person) and the second person are together as “60 seconds” by adding the time “10 seconds” corresponding to the first section, the time “30 seconds” corresponding to the second section, and the time “20 seconds” corresponding to the third section. Furthermore, the related person identification unit 130 can calculate the number of sections “3” in the moving image as the number of times the first person (designated person) and the second person appeared together. Then, the related person identification unit 130 compares at least one of the time of being with the first person (designated person) and the number of times appearing with the first person (designated person) calculated for the second person with a reference set in advance for determining the related person. The reference defines at least one of a reference time for determining as a related person and a number of appearances for determining as a related person. In addition, the reference is stored in advance in a storage area accessible by the related person identification unit 130 such as the storage device 1040. For example, in a case where the length of the time calculated for the second person is equal to or longer than the length of the reference time set in advance, the related person identification unit 130 may identify the second person as a related person. Furthermore, for example, in a case where the number of appearances calculated for the second person is equal to or greater than a reference number of times set in advance, the related person identification unit 130 may identify the second person as a related person. In addition, for example, in a case where both the time and the number of appearances calculated for the second person exceed the reference set for each, the related person identification unit 130 may identify the second person as a related person.

Next, the display output unit 140 generates the person relationship information and the organization information indicating the relationship between the designated person and the related person (step S108). Then, the display output unit 140 outputs a screen including the person relationship information and the organization information to the display 30 (step S110). For example, the display output unit 140 performs the following operation.

First, the display output unit 140 reads, from the database 20, the organization information of the designated person identified by the person designation input accepted by the designation input accepting unit 120. In addition, the display output unit 140 reads, from the database 20, the organization information of the person identified as the related person by the related person identification unit 130. Here, it is assumed that the organization information of the designated person indicates a first organization, and the organization information of the related person indicates a second organization different from the first organization. In this case, the display output unit 140 acquires an organization chart (first organization chart) of a first organization to which the designated person belongs and an organization chart (second organization chart) of a second organization to which the related person belongs. Data regarding the organization chart of each organization is stored in advance in a storage area accessible by the display output unit 140, such as for example, the storage device 1040. After acquiring the data of each of the first organization chart and the second organization chart from the storage area, the display output unit 140 generates drawing data of a screen including the first organization chart and the second organization chart as the organization information described above.

Furthermore, the display output unit 140 generates the person relationship information indicating the relationship between the designated person and the related person by using the first organization chart and the second organization chart. For example, the display output unit 140 identifies a portion corresponding to the designated person on the first organization chart (a position on the organization chart determined by a position, a hierarchy, etc.) based on the organization information acquired for the designated person. For example, the display output unit 140 identifies a portion corresponding to the related person on the second organization chart (a position on the organization chart determined by a position, a hierarchy, etc.) based on the organization information acquired for the related person. Then, the display output unit 140 generates the person relationship information between the two organization charts by using the position of the designated person on the first organization chart and the position of the related person on the second organization chart. The display output unit 140 combines the generated person identifying information with the drawing data of the screen, and outputs the combined information to the display 30.

As an example, the display output unit 140 outputs a screen as illustrated in FIG. 6 to the display 30. FIG. 6 is a diagram illustrating an example of a screen output by the display output unit 140. The screen illustrated in this figure includes a line that associates the position of the designated person (person H) with the positions of the related persons (person C and person F) between the first organization chart and the second organization chart. With such a line, the relationship between the designated person and the related person is visualized. For example, in the example of the drawing, a state in which a person C and a person F are identified as persons related to the designated person H is visualized by two lines L1 and L2. By utilizing such a screen, it is possible to easily grasp the relationship between the organizations of the designated person and the related person identified from the analysis result of the input video.

As another example, the display output unit 140 outputs a screen as illustrated in FIG. 7 to the display 30. FIG. 7 is a diagram illustrating another example of a screen output by the display output unit 140. The screen illustrated in this figure includes a star-shaped mark as a common mark for associating the designated person and the related person between the first organization chart and the second organization chart. The common mark may be any mark as long as the correspondence between the designated person and the related person can be identified. Thus, the relationship between the designated person and the related person is visualized by providing the common mark to the designated person and the related person. For example, in the example of the drawing, the state in which the person C and the person F are identified as the persons related to the designated person H is visualized by the star-shaped mark given to the position of each person. By utilizing such a screen, it is possible to easily grasp the relationship between the organizations of the designated person and the related person identified from the analysis result of the input video.

As another example, the display output unit 140 outputs a screen as illustrated in FIG. 8 to the display 30. FIG. 8 is a diagram illustrating another example of a screen output by the display output unit 140. In the screen illustrated in this drawing, the display output unit 140 sets a portion corresponding to the designated person in the first organization chart and a second portion corresponding to the related person in the second organization chart to a common display mode (common background pattern). The common display mode is arbitrary as long as the correspondence between the designated person and the related person can be identified. By utilizing such a screen, it is possible to easily grasp the relationship between the organizations of the designated person and the related person identified from the analysis result of the input video.

Furthermore, the display output unit 140 may be configured to output a screen in which two or more of the display examples of FIGS. 6 to 8 are combined to the display 30.

As described above, according to the present example embodiment, the screen including the person relationship information indicating the relationship between the designated person and the related person and the organization information regarding the organization to which the designated person and the related person respectively belong is output to the display 30. With such a screen, a person (person in charge of operation) who performs the operation of confirming an image can grasp the relationship between the designated person and the related person in more detail. For example, the person in charge of the operation can easily grasp the chain of command in the organization or between the organizations by confirming the screen output by the display output unit 140. In addition, for example, in a case where the person in charge of the operation is an investigator, efficiency of a group crime investigation by a plurality of members can be improved by a screen output by the display output unit 140.

### Modified Example of Second Example Embodiment

As a first modified example, the display output unit 140 may be configured to output additional information corresponding to the selected person relationship information in a case where an input for selecting the person relationship information is accepted on the screens illustrated in FIGS. 6 to 8. As an example, the display output unit 140 accepts an input for selecting a portion corresponding to the person relationship information on the screen. Then, the display output unit 140 identifies the designated person and the related person indicated by the selected person relationship information. Then, the display output unit 140 identifies one or more images in which both the designated person and the related person are photographed from among the plurality of images. Then, the display output unit 140 causes the display 30 to display the identified one or more images.

The operation of the image analysis device 10 (display output unit 140) according to the first modified example will be described with reference to the drawings. FIGS. 9 and 10 are diagrams for explaining the operation of the image analysis device 10 (display output unit 140) according to the first modified example of a second example embodiment. First, as illustrated in FIG. 9, the display output unit 140 accepts an input for selecting a portion (e.g., line L1/line L2) corresponding to the person relationship information on the screen displayed on the display 30. In the drawing, a state in which the line L1 corresponding to the person relationship information indicating the relationship between the designated person (person H) and the first related person (person C) is selected is drawn. The display output unit 140 further outputs a screen illustrated in FIG. 10, for example, in response to the selection input illustrated in FIG. 9. The screen of FIG. 10 includes an image in which both the person H and the person C are photographed and information indicating a region of each person in the image. As the image included in the screen illustrated in FIG. 10, a representative image is selected from a plurality of images processed by the attribute information acquisition unit 110. For example, the display output unit 140 can select an image in which each person appears largest as the representative image. Furthermore, as illustrated in FIG. 10, the display output unit 140 may further include a button for switching to another image in the screen. Furthermore, the image included in the screen illustrated in FIG. 10 may be partial moving image data obtained by cutting out a portion in which each person is photographed together from the original moving image data.

According to the first modified example, the person who confirms the video can easily browse the actual image in which both the designated person and the related person are photographed.

As a second modified example, the display output unit 140 may be configured to output, on the screen, an element for changing the reference used for identifying the related person in the related person identification unit 130. In this case, the display output unit 140 outputs, for example, a screen illustrated in FIG. 11 to the display 30. FIG. 11 is a diagram for explaining the operation of the image analysis device 10 (the related person identification unit 130 and the display output unit 140) according to the second modified example of the second example embodiment. The screen illustrated in FIG. 11 includes an element E for setting and changing a reference for identifying a related person at an upper right portion. The user performs, for example, an input for changing a reference regarding at least one of time and the number of times on the element E via an input device connected to the input/output interface 1050.

In a case where an input for changing the reference is made in the element E illustrated in FIG. 11, the related person identification unit 130 updates the identification result of the related person with respect to the designated person based on the new reference changed by the input.

For example, in the screen illustrated in FIG. 11, two related persons (person C and person F) are identified with respect to the designated person (person H). Here, it is assumed that the time the person C was with the person H and the number of times the person C appeared with the person H are calculated as “100 seconds” and “3 times”, respectively, based on the processing result of each image by the attribute information acquisition unit 110 (attribute information of each individual person acquired from each image). Furthermore, similarly, it is assumed that the time the person F was with the person H and the number of times the person F appeared with the person H are calculated as “200 seconds” and “5 times”, respectively. Then, it is assumed that an input for changing the reference time to “200 seconds” or an input for changing the reference number to “5 times” is performed in the element E of the screen illustrated in FIG. 11. In this case, the person C does not satisfy the new reference changed by the input. As a result, the related person identification unit 130 excludes the person C from the related persons and updates the screen display as illustrated in, for example, FIG. 12. FIG. 12 is a diagram illustrating a screen updated according to the input for changing the reference. In the screen of FIG. 12, unlike the screen of FIG. 11, only the person relationship information (line L2) indicating the relationship between the person H (designated person) and the person F (related person) remains.

As described in the second modified example, the reference for identifying the related person can be changed, so that the person related to the designated person can be more flexibly identified.

As a third modified example, the related person identification unit 130 may be configured to identify a related person by further using a “distance between persons”. In this case, the attribute information acquisition unit 110 further acquires, for example, a position of each person (position in image coordinate system or position in real world coordinate system corresponding to the position in image coordinate system) as an analysis result of the image to be processed. The attribute information acquisition unit 110 can use various known methods as a method of calculating the position of the object photographed in the image. Then, the related person identification unit 130 can calculate the distance between the designated person and each of the other persons based on the information regarding the position of each individual person acquired from each image. For example, the related person identification unit 130 calculates the distance (average value of the distances) to the designated person based on the position information acquired from each image for each person present with the designated person. Then, in a case where the distance calculated for a certain person satisfies a reference defined in advance (e.g., the calculated distance is equal to or less than the reference distance), the related person identification unit 130 identifies the person as a “related person”.

In this case, the display output unit 140 may be configured to output a screen as illustrated in FIG. 13. FIG. 13 is a diagram for explaining the operation of the image analysis device 10 (the related person identification unit 130 and the display output unit 140) according to the third modified example of the second example embodiment. The screen illustrated in FIG. 13 includes an element E for setting and changing a reference for identifying a related person at an upper right portion. Unlike the drawings according to the second modified example (FIGS. 11 and 12), the element E in this drawing is configured to be able to accept an input for changing the reference regarding the “distance”. For example, the user performs an input for changing a reference regarding at least one of the time, the number of times, and the distance on the element E via an input device connected to the input/output interface 1050.

In a case where an input for changing the reference is made in the element E illustrated in FIG. 13, the related person identification unit 130 updates the identification result of the related person with respect to the designated person based on the new reference changed by the input. For example, in the screen illustrated in FIG. 13, two related persons (person C and person F) are identified with respect to the designated person (person H). Here, it is assumed that, based on the processing result of each image by the attribute information acquisition unit 110 (attribute information of each individual person acquired from each image), the time during which the person C was with the person H, the number of times the person C appeared with the person H, and the distance while the person C was with the person H are calculated as “100 seconds”, “3 times”, and “0.5 m”, respectively. Similarly, it is assumed that the time the person F was with the person H, the number of times the person F appeared with the person H, and the distance while the person F was with the person H are calculated as “200 seconds”, “5 times”, and “1.0 m”, respectively. Then, it is assumed that an input to change the reference distance to “0.5 m” is performed in the element E of the screen illustrated in FIG. 13. In this case, the person F does not satisfy the new reference changed by the input. As a result, the related person identification unit 130 excludes the person F from the related persons. As a result, the display output unit 140 updates the screen display as illustrated in, for example, FIG. 14. FIG. 14 is a diagram illustrating a screen updated according to the input for changing the reference. In the screen of FIG. 14, unlike the screen of FIG. 13, only the person relationship information (line L1) indicating the relationship between the person H (designated person) and the person C (related person) remains.

According to the third modified example, a person having a high possibility of being related to the designated person can be accurately identified by the new index of “distance between persons”.

The image analysis device 10 may have a combination of the configuration according to the first modified example and the configuration according to the second modified example or the configuration according to the third modified example.

### Third Example Embodiment

FIG. 15 is a diagram illustrating a system configuration of an image analysis system 1 according to a third example embodiment. In the example of the drawing, the database 20 includes a posture information database 22. As illustrated in FIG. 16, for example, the posture information database 22 stores information regarding various postures that a person can take. FIG. 16 is a diagram illustrating an example of information stored in the posture information database. The posture information database 22 illustrated in this drawing stores a plurality of pieces of posture information including a posture image, a posture feature quantity (skeleton information), and a posture name.

The image analysis device 10 according to the present example embodiment has a functional configuration (e.g.: FIG. 1) similar to that of the first example embodiment and the second example embodiment except for the points described below.

The attribute information acquisition unit 110 according to the present example embodiment further identifies the posture or action of each individual person by using the skeleton information of each individual person photographed in the image to be processed. For example, the attribute information acquisition unit 110 compares skeleton information that can be extracted from an image region of a certain target person with skeleton information (hereinafter, also referred to as “registered skeleton information”) of various postures registered in the posture information database 22. The attribute information acquisition unit 110 identifies the registered skeleton information having the highest similarity among the plurality of pieces of registered skeleton information based on the comparison result. Then, the attribute information acquisition unit 110 acquires the name (e.g., “hand-over”, “sitting”, etc.) of the posture or the action corresponding to the identified registered skeleton information as information indicating the posture or the action of the target person. The attribute information acquisition unit 110 can execute such processing for each image and identify the posture and action of each individual person photographed in each image. Then, the attribute information acquisition unit 110 adds information indicating the identified posture or action of each individual person photographed in each image to the attribute information of the person. In addition, the related person identification unit 130 according to the present example embodiment is configured to be able to narrow down related persons with respect to the designated person based on the posture or action of the person included in the attribute information of each individual person.

The operation of the image analysis device 10 according to the present example embodiment will be described with reference to FIGS. 17 to 19. FIGS. 17 to 19 are diagrams for explaining the operation of the image analysis device 10 (the related person identification unit 130 and the display output unit 140) according to the third example embodiment.

First, the related person identification unit 130 accepts an input for identifying a specific posture or action. In this case, the display output unit 140 displays a screen as illustrated in, for example, FIG. 17 to accept an input for identifying the posture or the action. The screen illustrated in FIG. 17 includes an element E for setting and changing a reference for identifying a related person at an upper right portion. Unlike the screen illustrated in the example described above, the element E in the drawing is configured to be able to accept an input for changing the reference regarding the “posture/behavior”. The user can perform an input for changing the reference related to the posture or the behavior on the element E via, for example, an input device connected to the input/output interface 1050.

Here, as illustrated in FIG. 18, it is assumed that a specific posture (action) of “hand-over (of some object)” is designated by the user. In this case, the related person identification unit 130 identifies an image in which the designated person taking the “hand-over” posture is photographed by using the attribute information of the designated person acquired from each image. For example, the related person identification unit 130 can identify an image as illustrated in FIG. 19. In the image illustrated in FIG. 19, the designated person (person H) takes a “hand-over” posture. Furthermore, in the image illustrated in FIG. 19, “person C” is photographed as another person. The related person identification unit 130 narrows down other persons (“person C” in the example of FIG. 19) photographed together in the identified image as a related person. As a result, the person F is excluded from the related persons. The display output unit 140 updates the screen display as illustrated in FIG. 18 according to the result. In the screen of FIG. 18, unlike the screen of FIG. 17, only the person relationship information (line L1) indicating the relationship between the person H (designated person) and the person C (related person) remains.

With the new index of “posture of a person”, a person having a high possibility of being related to the designated person can be accurately identified.

In the present example embodiment, as described in the modified example of the second example embodiment, the related person identification unit 130 may narrow down the related persons in more detail by the reference related to the “distance”.

Although the example embodiments of the present invention have been described above with reference to the drawings, these are examples of the present invention, and various configurations other than the above can be used.

In the flowcharts used in the above description, a plurality of steps (types of processing) are described in order, but execution order of the steps executed in each example embodiment is not limited to the described order. In each example embodiment, the order of the illustrated steps can be changed as long as there is no problem in terms of content. The above-described example embodiments can be combined within a range in which the contents are not contradictory.

Some or all of the example embodiments described above may be described as the following Supplementary Notes, but are not limited to the following.

1.

An image analysis device including:
an attribute information acquisition means for acquiring attribute information indicating an attribute of a person for each individual person photographed in each image by processing a plurality of images,
a designation input accepting means for accepting a person designation input indicating a designated person,
a related person identification means for identifying a related person who is a person related to the designated person by using the attribute information acquired for each individual person, and
a display output means for outputting a screen including person relationship information indicating a relationship between the designated person and the related person and organization information regarding an organization to which each of the designated person and the related person belongs.
   2.

The image analysis device according to 1., in which
the display output means
includes, as the organization information, a first organization chart of an organization to which the designated person belongs and a second organization chart of an organization to which the related person belongs in the screen, and
generates the person relationship information using the first organization chart and the second organization chart.
   3.

The image analysis device according to 2., in which
the display output means generates, as the person relationship information, a line that associates the designated person and the related person between the first organization chart and the second organization chart.
   4.

The image analysis device according to 2., in which
the display output means generates, as the person relationship information, a common mark that associates the designated person and the related person between the first organization chart and the second organization chart.
   5.

The image analysis device according to 2., in which
the display output means generates the person relationship information by setting a first portion corresponding to the designated person in the first organization chart and a second portion corresponding to the related person in the second organization chart in a common display mode.
   6.

The image analysis device according to any one of 2. to 5., in which
the display output means displays one or more images in which both the designated person and the related person indicated by the selected person relationship information are photographed in response to accepting an input of selecting a portion corresponding to the person relationship information on the screen.
   7.

The image analysis device according to any one of 1. to 6., in which
the related person identification means
calculates, for every person, at least one of a time of being with the designated person and a number of times appearing together with the designated person based on the attribute information of each individual person acquired from each image, and
identifies the related person with respect to the designated person based on a result of comparing at least one of the time and the number of times calculated for every person with a reference set in advance for at least one of time and number of times.
   8.

The image analysis device according to 7., in which
the related person identification means updates, in response to accepting a reference change input for changing the reference, a identification result of the related person with respect to the designated person based on a new reference changed by the reference change input.
   9.

The image analysis device according to any one of 1. to 8., in which
the attribute of the person includes an attribute related to physical characteristics of the person.
   10.

An image analysis method including:
at least one computer,
acquiring attribute information indicating an attribute of a person for each individual person photographed in each image by processing a plurality of images,
accepting a person designation input indicating a designated person,
identifying a related person who is a person related to the designated person by using the attribute information acquired for each individual person, and
outputting a screen including person relationship information indicating a relationship between the designated person and the related person and organization information regarding an organization to which each of the designated person and the related person belongs.
   11.

The image analysis method according to 10., in which
the at least one computer
includes, as the organization information, a first organization chart of an organization to which the designated person belongs and a second organization chart of an organization to which the related person belongs in the screen, and
generates the person relationship information using the first organization chart and the second organization chart.
   12.

The image analysis method according to 11., in which
the at least one computer
generates, as the person relationship information, a line that associates the designated person and the related person between the first organization chart and the second organization chart.
   13.

The image analysis method according to 11., in which
the at least one computer
generates, as the person relationship information, a common mark that associates the designated person and the related person between the first organization chart and the second organization chart.
   14.

The image analysis method according to 11., in which
the at least one computer
generates the person relationship information by setting a first portion corresponding to the designated person in the first organization chart and a second portion corresponding to the related person in the second organization chart in a common display mode.
   15.

The image analysis method according to any one of 11. to 14., in which
the at least one computer
displays one or more images in which both the designated person and the related person indicated by the selected person relationship information are photographed in response to accepting an input of selecting a portion corresponding to the person relationship information on the screen.
   16.

The image analysis method according to any one of 10. to 15., in which
the at least one computer
calculates, for every person, at least one of a time of being with the designated person and a number of times appearing together with the designated person based on the attribute information of each individual person acquired from each image, and
identifies the related person with respect to the designated person based on a result of comparing at least one of the time and the number of times calculated for every person with a reference set in advance for at least one of time and number of times.
   17.

The image analysis method according to 16., in which
the at least one computer
updates, in response to accepting a reference change input for changing the reference, a identification result of the related person with respect to the designated person based on a new reference changed by the reference change input.
   18.

The image analysis method according to any one of 10. to 17., in which
the attribute of the person includes an attribute related to physical characteristics of the person.
   19.

A program for causing at least one computer to function as:
an attribute information acquisition means for acquiring attribute information indicating an attribute of a person for each individual person photographed in each image by processing a plurality of images,
a designation input accepting means for accepting a person designation input indicating a designated person,
a related person identification means for identifying a related person who is a person related to the designated person by using the attribute information acquired for each individual person, and
a display output means for outputting a screen including person relationship information indicating a relationship between the designated person and the related person and organization information regarding an organization to which each of the designated person and the related person belongs.
   20.

The program according to 19., in which
the display output means
includes, as the organization information, a first organization chart of an organization to which the designated person belongs and a second organization chart of an organization to which the related person belongs in the screen, and
generates the person relationship information using the first organization chart and the second organization chart.
   21.

The program according to 20., in which
the display output means generates, as the person relationship information, a line that associates the designated person and the related person between the first organization chart and the second organization chart.
   22.

The program according to 20., in which
the display output means generates, as the person relationship information, a common mark that associates the designated person and the related person between the first organization chart and the second organization chart.
   23.

The program according to 20., in which
the display output means generates the person relationship information by setting a first portion corresponding to the designated person in the first organization chart and a second portion corresponding to the related person in the second organization chart in a common display mode.
   24.

The program according to any one of 20. to 23., in which
the display output means displays one or more images in which both the designated person and the related person indicated by the selected person relationship information are photographed in response to accepting an input of selecting a portion corresponding to the person relationship information on the screen.
   25.

The program according to any one of 19. to 24., in which
the related person identification means
calculates, for every person, at least one of a time of being with the designated person and a number of times appearing together with the designated person based on the attribute information of each individual person acquired from each image, and
identifies the related person with respect to the designated person based on a result of comparing at least one of the time and the number of times calculated for every person with a reference set in advance for at least one of time and number of times.
   26.

The program according to 25., in which
the related person identification means updates, in response to accepting a reference change input for changing the reference, a identification result of the related person with respect to the designated person based on a new reference changed by the reference change input.
   27.

The program according to any one of 19. to 26., in which
the attribute of the person includes an attribute related to physical characteristics of the person.

This application is based upon and claims the benefit of priority from Japanese patent application No. 2023-075670, filed on May 1, 2023, the disclosure of which is incorporated herein in its entirety by reference.

### REFERENCE SIGNS LIST

1 image analysis system
10 image analysis device
1000 computer
1010 bus
1020 processor
1030 memory
1040 storage device
1050 input/output interface
1060 network interface
110 attribute information acquisition unit
120 designation input accepting unit
130 related person identification unit
140 display output unit
20 database
22 posture information database
30 display
40 network

What is claimed is:

1. An image analysis apparatus comprising:
at least one memory storing instructions; and
at least one processor configured to execute the instructions to perform operations comprising:
acquiring attribute information indicating an attribute of a person for each individual person photographed in each image by processing a plurality of images;
accepting a person designation input indicating a designated person;
identifying a related person who is a person related to the designated person by using the attribute information acquired for each individual person; and
outputting a screen including person relationship information indicating a relationship between the designated person and the related person and organization information regarding an organization to which each of the designated person and the related person belongs.

2. The image analysis apparatus according to claim 1, wherein the operations further comprise
includes, including, as the organization information, a first organization chart of an organization to which the designated person belongs and a second organization chart of an organization to which the related person belongs in the screen, and
generating the person relationship information using the first organization chart and the second organization chart.

3. The image analysis apparatus according to claim 2, wherein the operations further comprise
generating, as the person relationship information, a line that associates the designated person and the related person between the first organization chart and the second organization chart.

4. The image analysis apparatus according to claim 2, wherein the operations further comprise
generating, as the person relationship information, a common mark that associates the designated person and the related person between the first organization chart and the second organization chart.

5. The image analysis apparatus according to claim 2, wherein the operations further comprise
generating the person relationship information by setting a first portion corresponding to the designated person in the first organization chart and a second portion corresponding to the related person in the second organization chart in a common display mode.

6. The image analysis apparatus according to claim 2, wherein the operations further comprise
displaying one or more images in which both the designated person and the related person indicated by the selected person relationship information are photographed in response to accepting an input of selecting a portion corresponding to the person relationship information on the screen.

7. The image analysis apparatus according to claim 1, wherein the operations further comprise
calculating, for every person, at least one of a time of being with the designated person and a number of times appearing together with the designated person based on the attribute information of each individual person acquired from each image, and
identifying the related person with respect to the designated person based on a result of comparing at least one of the time and the number of times calculated for every person with a reference set in advance for at least one of time and number of times.

8. The image analysis apparatus according to claim 7, wherein the operations further comprise
updating, in response to accepting a reference change input for changing the reference, a identification result of the related person with respect to the designated person based on a new reference changed by the reference change input.

9. The image analysis apparatus according to claim 1, wherein
the attribute of the person includes an attribute related to physical characteristics of the person.

10. An image analysis method comprising:
at least one computer
acquiring attribute information indicating an attribute of a person for each individual person photographed in each image by processing a plurality of images;
accepting a person designation input indicating a designated person;
identifying a related person who is a person related to the designated person by using the attribute information acquired for each individual person; and
outputting a screen including person relationship information indicating a relationship between the designated person and the related person and organization information regarding an organization to which each of the designated person and the related person belongs.

11. The image analysis method according to claim 10, wherein
the at least one computer
includes, as the organization information, a first organization chart of an organization to which the designated person belongs and a second organization chart of an organization to which the related person belongs in the screen, and
generates the person relationship information using the first organization chart and the second organization chart.

12. The image analysis method according to claim 11, wherein
the at least one computer
generates, as the person relationship information, a line that associates the designated person and the related person between the first organization chart and the second organization chart.

13. The image analysis method according to claim 11, wherein
the at least one computer
generates, as the person relationship information, a common mark that associates the designated person and the related person between the first organization chart and the second organization chart.

14. The image analysis method according to claim 11, wherein
the at least one computer
generates the person relationship information by setting a first portion corresponding to the designated person in the first organization chart and a second portion corresponding to the related person in the second organization chart in a common display mode.

15. The image analysis method according to claim 11, wherein
the at least one computer
displays one or more images in which both the designated person and the related person indicated by the selected person relationship information are photographed in response to accepting an input of selecting a portion corresponding to the person relationship information on the screen.

16. The image analysis method according to claim 10, wherein
the at least one computer
calculates, for every person, at least one of a time of being with the designated person and a number of times appearing together with the designated person based on the attribute information of each individual person acquired from each image, and
identifies the related person with respect to the designated person based on a result of comparing at least one of the time and the number of times calculated for every person with a reference set in advance for at least one of time and number of times.

17. The image analysis method according to claim 16, wherein
the at least one computer updates, in response to accepting a reference change input for changing the reference, a identification result of the related person with respect to the designated person based on a new reference changed by the reference change input.

18. The image analysis method according to claim 10, wherein the attribute of the person includes an attribute related to physical characteristics of the person.

19. A non-transitory computer-readable medium recorded with a program to be executed by at least one computer to cause the computer to execute operations comprising:
acquiring attribute information indicating an attribute of a person for each individual person photographed in each image by processing a plurality of images;
accepting a person designation input indicating a designated person;
identifying a related person who is a person related to the designated person by using the attribute information acquired for each individual person; and
outputting a screen including person relationship information indicating a relationship between the designated person and the related person and organization information regarding an organization to which each of the designated person and the related person belongs.
